(19) United States
(12) Patent Application Publication
(10) Pub. No.: US 2011/0157031 A1
(43) Pub. Date: Jun. 30, 2011

(54) METHOD AND SYSTEM FOR DRAWING LINES IN ELECTRONIC BOOK USING ELECTRONIC BOOK READER

(75) Inventor: QING-HUA LIU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/723,706

(22) Filed: Mar. 15, 2010

(30) Foreign Application Priority Data
Dec. 29, 2009 (CN) 200910312622.7

(51) Int. Cl. G06K 11/06; G06F 3/041

(52) U.S. Cl. 345/173; 345/441

(57) ABSTRACT

An e-book reader includes a touch screen, a touch screen control module connected to the touch screen, and a drawing line module. The drawing line module includes a transparent window unit and a line trace recording unit. The line trace recording unit is connected to the touch screen control module for recording lines drawn on the touch screen. The transparent window unit includes a transparent window which is displayed on the touch screen. The lines are shown in the transparent window by the transparent window unit.

### BACKGROUND

1. Technical Field

The present disclosure relates to drawing lines, and particularly to, a method and system for drawing lines in an electronic book using an electronic book reader.

2. Description of Related Art

An electronic book (e-book) is a text file providing the digital media equivalent of a conventional printed book. E-books are usually read on personal computers or smart phones, or on dedicated hardware devices known as e-book readers. An e-book reader is capable of containing many e-books, and being more convenient to use than traditional printed books.

However, it is often inconvenient to mark highlights on the e-book, such as drawing lines below texts of the e-book.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a system for drawing lines in an e-book.

FIG. 2 is a flow chart of a method for drawing lines in an e-book.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

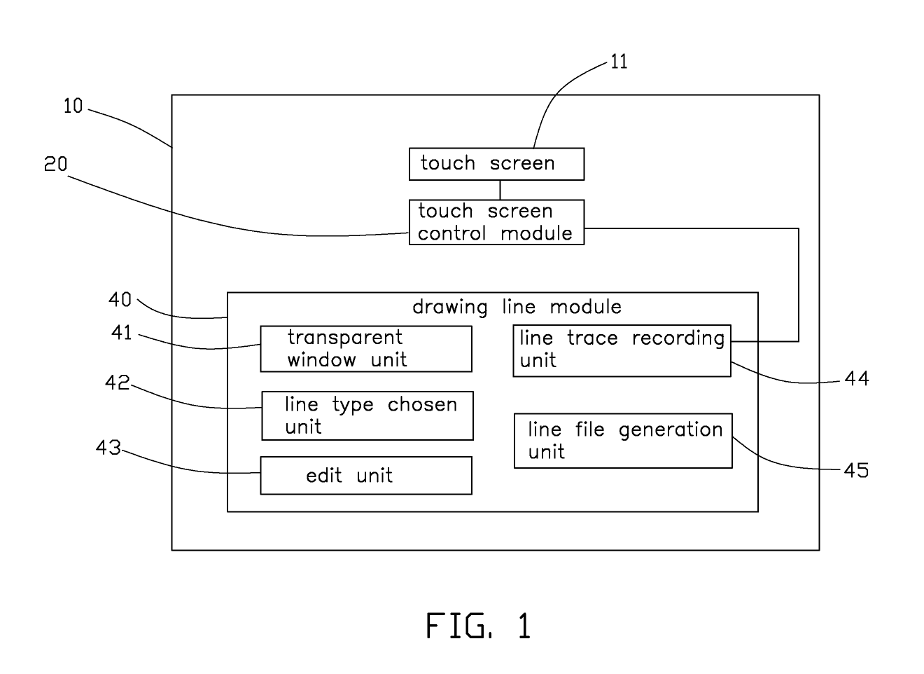

Referring to FIG. 1, an e-book reader 10 is capable of drawing lines in e-books. The e-book reader 10 includes a touch screen 11, a touch screen control module 20, and a drawing line module 40. The touch screen control module 20 is connected to the touch screen 11. The drawing line module 40 includes a transparent window unit 41, a line type chosen unit 42, an edit unit 43, a line trace recording unit 44, and a line file generation unit 45.

The transparent window unit 41 generates a transparent window. The transparent window is a display window that appears transparent on the touch screen 11. The transparent window can show lines generated by the drawing line module 40 therein. When an e-book is opened in the e-book reader 10, the transparent window is displayed on the touch screen 11, and the lines are shown in the transparent window. Because the transparent window is transparent, the e-book and the lines can be simultaneously seen in the touch screen 11.

The line type chosen unit 42 defines different types of lines, which may include straight lines, wavy lines, dotted lines etc. These different types of lines can be chosen to be drawn on e-books.

The edit unit 43 can edit the lines shown in the transparent window. For example, the edit unit 43 can change positions of the lines in the transparent window, erase selected lines, changes colors of the lines, changes widths of the lines etc.

The line trace recording unit 44 is connected to the touch screen control module 20. After the transparent window is displayed on the touch screen 11, a user or student can draw lines on the touch screen 11. The line trace recording unit 44 records start and end positions of each of the lines.

The line file generation unit 45 generates a line file based on the lines and the corresponding e-book. The line file stores information, which may include colors of the lines, positions of the lines, types of the lines, widths of the lines etc. The line file generation unit 45 then transmits the line file to the transparent window unit 41. The transparent window unit 41 shows the lines in the transparent window.

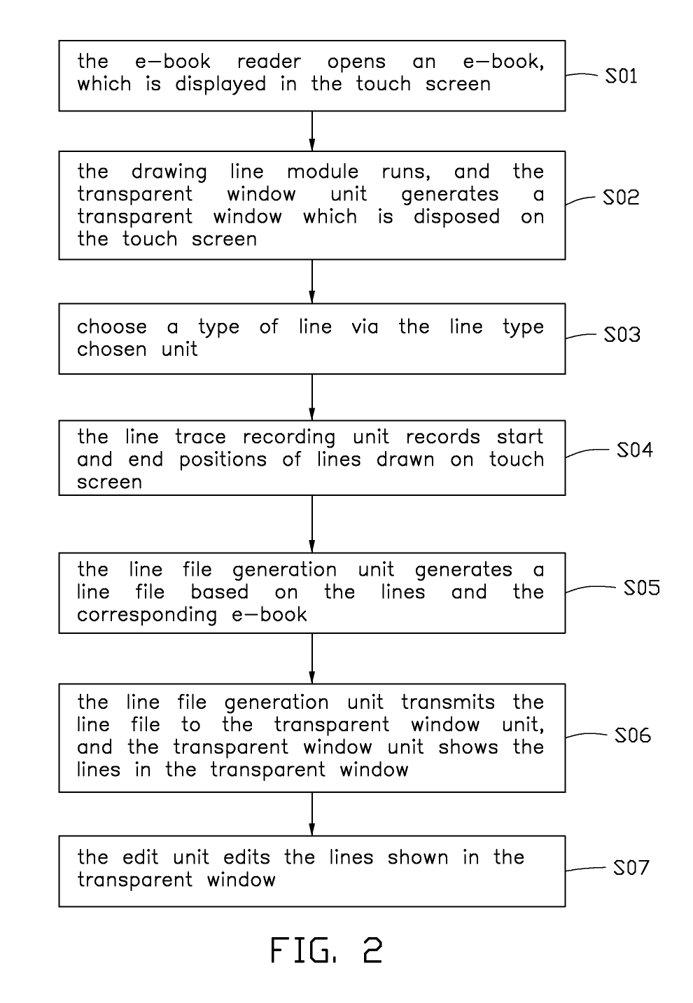

Referring to FIG. 2, a method for drawing lines on an e-book is shown, as follows.

In step S01, the e-book reader 10 opens an e-book, which is displayed in the touch screen 11.

In step S02, the drawing line module 40 runs, and the transparent window unit 41 generates a transparent window which is disposed on the touch screen 11.

In step S03, a type of line is chosen via the line type chosen unit 42.

In step S04, the line trace recording unit 44 records start and end positions of lines drawn on touch screen 11.

In step S05, the line file generation unit 45 generates a line file based on the lines and the corresponding e-book.

In step S06, the line file generation unit 45 transmits the line file to the transparent window unit 41, and the transparent window unit 41 shows the lines in the transparent window.

In step S07, the edit unit 43 can be used to edit the lines shown in the transparent window.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An e-book reader, comprising:
a touch screen;
a touch screen control module connected to the touch screen; and
a drawing line module comprising a transparent window unit and a line trace recording unit, the line trace recording unit connected to the touch screen control module for recording lines drawn on the touch screen; the transparent window unit comprising a transparent window displayed on the touch screen, the recorded lines shown in the transparent window by the transparent window unit.

2. The e-book reader of claim 1, wherein the drawing line module comprises an edit unit which is capable of editing the lines.

3. The e-book reader of claim 2, wherein the edit unit is capable of changing positions of the lines.

4. The e-book reader of claim 2, wherein the edit unit is capable of erasing unneeded lines.

5. The e-book reader of claim 2, wherein the edit unit is capable of changing colors of the lines.

6. The e-book reader of claim 2, wherein the edit unit is capable of changing widths of the lines.

7. The e-book reader of claim 1, wherein the line trace recording unit records start and end positions of each of the lines.

8. The e-book reader of claim 1, wherein the drawing line module comprises a line file generation module, which is capable of generation a line file based on the lines and the e-book.

9. The e-book reader of claim 8, wherein the line file stores at least one of the information of colors of the lines, position of the lines, types of the lines, and widths of the lines.

10. The e-book reader of claim 1, wherein the drawing line module comprises a line type chosen unit which defines different types of lines for being chosen to show in the transparent window.

11. A method for drawing lines in an e-book, comprising:
the e-book being opened by an e-book reader, and displayed on a touch screen of the e-book reader;
a transparent window, which is generated by a transparent window unit of a drawing line module, displayed on the touch screen;
lines, which are drawn on the touch screen, being recorded by a line trace recording unit of the drawing line module; and
the lines being shown in the transparent window.

12. The method of claim 11, wherein a line file is generated based on the lines and the e-book by a line file generation module.

13. The method of claim 12, wherein the line file is transmitted to the transparent window unit, and the transparent window unit shows the lines in the transparent window based on the line file.

14. The method of claim 12, wherein the line file stores at least one of the information of colors of the lines, position of the lines, types of the lines, and widths of the lines.

15. The method of claim 11, wherein the lines shown in the transparent window is edited by an edit unit 43 of the drawing line module.

16. The method of claim 11, wherein the line trace recording unit records start and end positions of each of the lines.
